(19) United States
(12) Patent Application Publication
(10) Pub. No.: US 2004/0146625 A1
(43) Pub. Date: Jul. 29, 2004

(54) Process for granulation of reduced fat chocolate powder

(76) Inventor: Albert Zumbe, Geneva (CH)

Correspondence Address: Dickstein Shapiro, Morin & Oshinsky, 41st Floor, 1177 Avenue of the Americas, New York, NY, 10036-2714, US

(21) Appl. No.: 10/475,323

(22) PCT Filed: May 2, 2002
(86) PCT No.: PCT/EP02/06445

(30) Foreign Application Priority Data
May 2, 2001 (GB) 0110751.5

(51) Int. Cl. A23G 1/00

(52) U.S. Cl. 426/593

(57) ABSTRACT

This invention relates to the manufacture of good quality reduced fat chocolate. A process for producing granulated reduced fat chocolate power is provided. Agglomerating reduced fat chocolate powder by addition of an aqueous composition to produce agglomerated powder and drying to remove the aqueous composition forming granules of up to 5 mm in diameter. The granules produced as a result of this invention provide many advantages, these include chocolate in granule form which is easier to manipulate industrially than other forms of chocolate such as powder, the granules have good flavour as conching or other flavour development step was carried out on the composition and fat is removed without damaging the flavour.

This invention relates to the manufacture of chocolate and more specifically to the manufacture of good quality reduced fat chocolate.

Internationally accepted nutritional guidelines propose that fat should provide no more than 30-35% of the total energy of the diet. Chocolate is a food with a high fat content typically providing more than 50% of its total energy. In countries where overweight and obesity are common there is strong consumer demand for reduction in fat content of foods, from which chocolate is not exempt.

Many attempts have been made to make chocolate of good quality with reduced fat content. One successful process is disclosed in U.S. Pat. No. 5,882,709. The process involves developing the chocolate flavour during normal chocolate making procedure up to and including conching, followed by removal of some of the fat, for example by means of a cocoa liquor press.

The process allows not only for manufacture of good quality reduced fat chocolate, but also of superior flavour reduced fat chocolate powder made by particle size reduction of the chocolate immediately after fat removal. The fat content of the chocolate powder being normally in the range up to 24% by weight.

This chocolate powder has a wide variety of uses, but it is not ideal where good free flowing properties are required.

The first aspect of this invention provides a process for producing granulated reduced fat chocolate powder wherein reduced fat chocolate powder is formed by a process comprising the steps of

i) mixing together chocolate making ingredients including at least one cocoa ingredient selected from the group consisting of cocoa liquor, cocoa butter, cocoa butter substitutes and non fat cocoa solids, and at least one sweetener selected from the group of sugar and other sweeteners so as to produce a chocolate composition having a fat content which is higher than that required in the reduced fat chocolate to be manufactured,

ii) subjecting said chocolate composition to a flavour development step by conching, and

iii) after said conching step, removing some of the fat from said chocolate composition to reduce the fat content to a level of less than 18% by weight and wherein the resulting reduced fat chocolate powder has a particle size of less than 100 microns;

the granulation is characterised in that the process comprises the steps of

agglomerating the reduced fat chocolate powder by addition of an aqueous composition to produce agglomerated powder and

drying to remove the aqueous composition forming granules of up to 5 mm in diameter.

The granules produced as a result of this invention provide many advantages, these include chocolate in granule form which is easier to manipulate industrially than other forms of chocolate such as powder, the granules have good flavour as conching was carried out on the composition and fat is removed without damaging the flavour, additionally the granules are useful in producing chocolate products such as chocolate bars and drinking chocolate.

The manufacture of reduced fat chocolate powder is described in U.S. Pat. No. 5,882,709 which illustrated that, surprisingly, it was possible to reduce the total fat content of chocolate to as low as about 7% by weight using the presses normally used for pressing cocoa liquor and involves the procedures described below.

The process can be employed to effect partial removal of the fat from conventionally manufactured white, plain or milk chocolate, or it can be employed in the manufacture of low calorie chocolate in which sugar has been replaced by polyol(s) and/or bulking agent(s). Thus, the process involves starting with chocolate-making ingredients comprising cocoa butter, non-fat cocoa solids (in the case of plain or milk chocolate), milk solids (in the case of milk or white chocolate), and sugar (which may be at least partially replaced by polyol(s) and/or bulking agent(s) in the case of low calorie chocolate). In some cases, cocoa butter substitutes or replacement fats may be used in the place of at least a proportion of the cocoa butter. An emulsifier (e.g. lecithin) will also normally be included in a minor amount (typically about 0.5% by weight of the total chocolate composition), the amount used being included in the specified total fat content of the chocolate composition. Such chocolate-making ingredients may then be processed in a conventional manner for chocolate-making, e.g. by mixing or kneading, then refining and conching. Some of the cocoa butter (and emulsifier when used) may be added during the conching stage to promote the required flavour development.

The total fat content required at the conching stage varies depending upon the nature of the other chocolate-making ingredients, but it is generally considered that a total fat content of the chocolate of at least 25% by weight is required. However, at the conching stage, the total fat content is generally not less than about 29% by weight. To ensure adequate conching, even higher total fat contents may be required when polyol(s) and bulking agents are employed. Generally speaking, the total fat content of the chocolate during conching is in the range of 25 to about 45% by weight.

Conching is the traditional processing employed to develop the flavour and texture of high quality chocolate, for which equipment such as a roller conche, rotary conche, double beating conche or continuous conche may be used. The flavour and textural changes arising from conching include loss of undesirable aromatic volatiles that contribute to poor flavour, complete dispersal of solids in liquid fat and mellowing of flavour during sustained mixing.

Following conching the chocolate composition is then partially de-fatted. De-fatting may be effected so that the resultant chocolate composition has a total fat content corresponding to that required in the final chocolate composition, e.g. less than 18% by weight.

Under current legislation, some chocolate compositions should not contain less than 25% by weight of total fat if the product is to be sold as chocolate. However, it is within the scope of this method to reduce the total fat content in the de-fatting step down to a lower level (e.g. down to as low as 7 to 10% by weight) than that required in the final chocolate composition and then to add additional fat (reduced calorie or otherwise) to raise the fat content to the finally required level. This has the advantage that, since the additional fat is not intimately bound onto the surfaces of the solid particles in the chocolate composition, it can impart improved fluidity as compared with a chocolate composition which has simply been de-fatted to the same total fat content.

In a preferred method, chocolate as described above is heated with stirring to 25° C. to 90° C., preferably in the range 40° C. to 65° C. for milk and white chocolate and up to 90° C. for plain chocolate, and pumped to a press, preferably a horizontal cocoa press. In the press, a pressure of 10 to 1000 bar, preferably 400 to 1000 bar, is applied to express fat until chocolate with the desired fat content remains that is a composition of less than 18% fat.

Alternatively, the fat reduction of the chocolate may be effected by solvent extraction using a suitable solvent, e.g. carbon dioxide. Such extraction may be effected on the chocolate when in powder form under high pressure using either liquid or supercritical carbon dioxide. The use of liquid carbon dioxide may be preferred because of its weaker salvation power and its greater selectivity. Preferably, solvent extraction using liquid carbon dioxide is effected at about 10° C. under a pressure of about 300 bar. The extracted fat contains a large amount of the chocolate flavouring and can be re-cycled or used to avoid wastage. An alternative solvent extraction medium is an organic solvent, e.g. petroleum ether. However, care should be taken to ensure that the resultant chocolate composition contains no organic solvent residues.

A further technique for fat removal may be by centrifugation of the heated liquid chocolate.

The granules of the first aspect of the current invention are produced by either of two methods. Both involve agglomerating the reduced fat chocolate powder produced as described above by addition of an aqueous composition, a subsequent drying stage to remove the aqueous composition and the formation of granules of up to 5 mm in diameter.

In the first processes the aqueous composition is sprayed onto or into a fluidised mass or moving flow of the reduced fat chocolate powder in the agglomeration step. The aqueous composition used to agglomerate the reduced fat chocolate powder is generally water or steam. Therefore water may be sprayed onto or steam injected into a fluidised mass or moving flow of reduced fat chocolate powder. Alternatively the aqueous composition is a mixture of two or more food substance compatible polar solvents which includes water. For example the aqueous composition may be a mixture of ethanol and water.

The first process additionally comprises fluidisation of the agglomerated powder on a vibrating bed before the drying step, additionally or alternatively the process comprises cooling of the agglomerate simultaneously with or after the drying step.

This first process is valid for all types of chocolate powder, plain, white and milk which may contain sugar and/or other sweeteners (such as fructose, malititol, xylitol, sorbitol, isomalt, etc) in an amount between 0 and 70%, but preferably about 20%. The initial chocolate powder preferably has a water content of between 2 and 6%. The water content in the resulting granules is preferably equal to or less than 5%. In a process where the aqueous composition is steam the amount of steam is preferably between 0.5 and 3 times the amount of product, for example 50 to 300 kg of steam would be used for each 100 kg of reduced fat chocolate powder.

Once the reduced fat chocolate powder is agglomerated the mixture can be fluidified and then dried. During these steps the temperature of the air used during fluidification and the air used during drying is preferably between 100 and 130° C. The air used in these processes may be filtered air. The drying preferably takes place in a rotary drum. Preferably the product is then cooled to room temperature in the last section of the rotary drum.

The size of the granules obtained can be up to 5 mm in diameter while preferably they are in the range of from 0.5 mm to 2 mm in diameter. The resulting granule size required depends on the final use of the granulated product. The different sizes can be obtained by modifying several parameters of the process including altering the rate of flow of reduced fat chocolate powder at the start of the agglomeration step, the composition of the reduced fat chocolate powder, the amount of steam used to agglomerate the reduced fat chocolate powder, etc.

The resulting granules are of porous structure and are instantaneously soluble or dispersible (meaning that there is no formation of clumps of granules) when added to water or other liquids and the special characteristic aroma and taste of the original reduced fat chocolate powder is conserved. Additional lecithin and/or other emulsifying agents can be added into the reduced fat chocolate powder to improve the instant dispersion properties of the granules in liquids such as milk or water. Other dry food ingredients including milk or milk derivatives, sugars and/or sugar substitutes can be added to the reduced fat chocolate powder before the granules are formed.

Generally the granules formed as a result of the above described process are soft, meaning that the granules offer little resistance to the teeth. Alternatively sugar can be added to the reduced fat chocolate powder and the granules resulting from the above described process are crunchy, meaning that they offer more resistance to the teeth and a harsh noise may be heard when the granules are crushed. The sugar added to the reduced fat chocolate powder is usually in powder form.

In the second of the two methods for producing granulated reduced fat chocolate powder the agglomeration and drying steps as described above are part of a freeze drying process carried out on the reduced fat chocolate powder.

We believe that this is the first time that granulation of reduced fat chocolate powder by a freeze drying method has been performed. Therefore this invention also covers granulation, by freeze drying, of reduced fat chocolate powder of good quality produced by a method which allows any flavour development step to be carried out on the chocolate composition before a fat removal step. Hence a second aspect of this invention is a process for producing granulated reduced fat chocolate powder wherein reduced fat chocolate powder is formed by a process comprising the steps of

i) mixing together chocolate making ingredients including at least one cocoa ingredient selected from the group consisting of cocoa liquor, cocoa butter, cocoa butter substitutes and non fat cocoa solids, and at least one sweetener selected from the group of sugar and other sweeteners so as to produce a chocolate composition having a fat content which is higher than that required in the reduced fat chocolate to be manufactured,

ii) subjecting said chocolate composition to a flavour development step, and

iii) after said flavour development step, removing some of the fat from said chocolate composition to reduce the fat content to a level of less than 18% by weight and wherein the resulting reduced fat chocolate powder has a particle size of less than 100 microns;

the granulation is characterised in that the process comprises the steps of

agglomerating the reduced fat chocolate powder by addition of an aqueous composition to produce agglomerated powder and

drying to remove the aqueous composition forming granules of up to 5 mm in diameter, and wherein agglomeration and drying are part of a freeze drying process carried out on the reduced fat chocolate powder. A flavour development step includes conching as described above but also includes mixing or kneading in which ingredients are thoroughly mixed or kneaded together, or addition of chocolate flavouring substances which can replace conching.

The freeze drying process comprises the steps of

a) suspension or dissolution in an aqueous composition of said reduced fat chocolate powder to produce a suspension/solution of the reduced fat chocolate powder;

c) freezing to below −20° C. to create a frozen slab of suspended or dissolved powder;

d) granulation of the frozen slab to give granule sizes of about 0.5 mm to 5 mm in diameter;

e) removing the aqueous composition from the granule at a pressure less than 1 mbar.

It is preferred that freezing in step c) is at or below −30° C.

The process may additionally comprise step b), between steps a) and c) comprising stabilizing the suspension/solution by foaming with carbon dioxide or nitrogen and/or precooling the solution/suspension before the freezing step c) to −5° C. to 0° C.

Alternatively or additionally the process may comprise step f) after step e), comprising recovering aromatic volatiles lost during freeze drying.

In the second method of granulating reduced fat chocolate powder, preferably the precooling temperature of step b) is about −3 to −4° C.

It is preferred that the freezing at step c) to create a frozen slab of the suspended or dissolved powder comprises cold air blast or using a freezing drum.

It is also preferred that the freeze drying at step e) is carried out at pressures of about 0.4 to 0.6 mbar. During most of the freeze drying step the granules are at temperatures of below −18° C. The sublimation of the aqueous composition from a frozen solid to vapour is slow and the temperature of the granules may rise in the final stages. The product temperatures are always 55° C. or less and preferably 40° C. or less.

The resulting product of a freeze drying process (of either the first or second aspect of this invention), is soft chocolate granules substantially the same as freeze dried coffee granules in both appearance and texture. Additionally these chocolate granules could be reconstituted easily with hot or cold water, or milk to give an attractive chocolate beverage. The fact that the granules are very similar in size and texture to freeze dried coffee offers the ability to provide a granulated mocha by simple admixture of chocolate and coffee granules.

Additionally adding sugar to the reduced fat chocolate powder before carrying out the steps of freeze-drying, it is possible to make a crunchy chocolate granule. Although the sensation to the teeth was crunchy, the chocolate melted easily and smoothly without roughness in the mouth. It was discovered that the precise texture could be varied by altering the fat content of the chocolate powder and/or the quantity of sugar added.

In a granulation process of this invention granulated reduced fat chocolate powder is produced as a result of processes carried out on reduced fat chocolate powder. Whilst powder with a particle size of less than 100 microns gives good results, the reduced fat chocolate powder will have a sandy texture. If a sandy texture is required then a reduced fat chocolate powder with particle size of preferably less than 75 microns is used. Alternatively smoother reduced fat chocolate powder with no sandy texture may be required for some uses then preferably powder with particle size of less than 40 microns or more preferably less than 25 microns is used.

The ability to make bars, shapes etc with low fat chocolate which is at once crunchy in texture yet smooth in the mouth opens opportunities in many confectionery areas. The fact that these products can be very low in fat means for example that they may be coated with traditional chocolate coating and still be classified as low fat chocolate.

The granules produced according to this invention can be manipulated to obtain granules within a specific size range. The manipulation may be, for example, by sieving. The size of granule required will depend on the intended use.

A third aspect of this invention is the use of the granulated reduced fat chocolate powder made as described above in the manufacture of a chocolate product.

For example chocolate made by using granulated reduced fat chocolate powder made according to the second method is mixed with full fat chocolate (usually in the range 25-45% fat) to make a chocolate; and depending on the proportions of these two ingredients used the total fat content of the resulting mix can be selected.

A fourth aspect provides a reduced fat chocolate product made with the granulated reduced fat chocolate powder, produced as described above. This product differs from other chocolate products because it does not stick to the mouth. The granules do not dissolve into the chocolate mass. One theory is that the liquid full fat chocolate binds the granules or sticks the granules together. The granules alone melt away in the mouth as they are dissolved in the saliva.

The chocolate products of this invention preferably comprise:

up to 55% of the granulated reduced fat chocolate powder,

chocolate containing 25-45% fat and

optionally another fat containing ingredient, preferably cocoa butter.

Generally the chocolate containing 25-45% fat used to produce reduced fat chocolate products is tempered chocolate.

An advantage of the invention is that tempered reduced fat chocolate can be made using the granulated reduced fat chocolate powder. Low fat chocolate of the prior art is too viscous to be able to be tempered by known procedures. However, because the granulated reduced fat chocolate powder remains as discrete granules, the surrounding tempered full fat chocolate (25 to 45% fat) remains tempered after its addition.

An unexpected use of granulated reduced fat chocolate powder was discovered as an ingredient allowing manufacture of low density reduced fat chocolate with better mouthfeel than regular chocolate. For example a quantity of full fat chocolate is stirred in a mixer at about 40° C. A quantity of low fat granulated chocolate, calculated to give the required final fat content of the mixture, is then slowly added with continuous stirring. The mass takes the form of cohesive balls of chocolate but is readily mixed. Further ingredients may be added to this mass such as 2.5% tempered cocoa butter and emulsifiers such as up to 0.85% ammonium phosphatide and up to 0.5% polyglycerol polyricinoleate; all percentages based on total weight of chocolate mass.

The mixing is then continued until the cohesive chocolate balls begin to stick to one another, but before a single mass has been obtained. It can then be put directly into moulds, or into an extruder and expressed as a sheet or an extruded shape. The chocolate is easily demoulded and has the gloss associated with regular chocolate. However, it has a unique mouthfeel and taste impact; it does not stick to the palate and disperses rapidly to give a powerful chocolate sensation. This chocolate is found to have up to 50% reduction in density compared with regular chocolate.

Alternatively, mixing is continued until a single apparently homogenous mass is first formed. It can then be moulded and demoulded easily or extruded. Again the demoulded chocolate has the gloss associated with regular chocolate and the unique mouthfeel and taste impact is as described above. There is also some reduction in density compared with regular chocolate, but less than that described above.

The effect of chocolate granules in improving mouthfeel and taste impact is surprising. Without being tied to any particular theory, it may be that the mixing is incomplete and that the chocolate which consists of granulated reduced fat chocolate powder coated in a thin layer of regular chocolate, is readily dispersed by saliva preventing mouth coating and allowing more intense flavour to be experienced. The fact that the chocolate mass is in some sense particulate may explain the reduction in density.

The invention is now further described using the following examples which in no way limit the scope of the invention.

### EXAMPLE 1

Preparation of Reduced Fat Plain Chocolate Powder

TABLE 1

| | Plain Chocolate |
|---|---|
| Ingredient | % by wt |
| Sugar | 41.58 |
| Cocoa liquor | 35.05 |
| Cocoa butter | 23.36 |
| Wholemilk powder | |
| Skimmilk powder | |
| Hazelnut paste | |
| Lecithin | |
| Vanillin | 0.01 |
| Total fat content (approx) | 42.6 |

The ingredients for plain chocolate given in Table 1 above are weighed to provide a 210 kg batch. Cocoa liquor, sugar and vanillin are added to a melangeur followed by 44 kg cocoa butter and mixed until homogenous. It is then passed through a five roll refiner to reduce the average particle size to about 25 microns. This refined mass is then conched at 80° C. for 7 hours, the remaining cocoa butter is added and conching continued for a further 2 hours at 80° C.

The conched chocolate is pumped to the pots of a horizontal cocoa liquor press and the filling valves closed. A pressure of 500 bar is applied until 76. 1 kg fat is expelled. The resultant press cakes are broken up and nibbled to small pieces of less than 10 mm diameter before milling to a fine powder in a pin mill fitted with mechanical classifier; the milling chamber being cooled by circulating cool air at 12° C. The particle size of the powder is such that 99.5% by weight passes a 75 microns sieve.

### EXAMPLE 2

Preparation of Reduced Fat Milk Chocolate Powder

TABLE 2

| | Milk Chocolate |
|---|---|
| Ingredient | % by wt |
| Sugar | 45.0 |
| Cocoa liquor | 13.0 |
| Cocoa butter | 17.0 |
| Wholemilk powder | 19.0 |
| Skimmilk powder | 3.49 |
| Hazelnut paste | 2.0 |
| Lecithin | 0.5 |
| Vanillin | 0.01 |
| Total fat content (approx) | 30.9 |

The ingredients for milk chocolate given in Table 2 above are weighed to provide a 210 kg batch. Cocoa liquor, wholemilk powder, sugar, skimmilk powder, hazelnut paste and vanillin are added to a melangeur followed by 32 kg cocoa butter and mixed until homogeneous. It is then passed through a five roll refiner to reduce the average particle size to about 25 microns. This refined mass is then conched at 80° C. for 7 hours, the remaining cocoa butter and the lecithin are added and conching continued for a further 2 hours at 80° C.

The conched chocolate is pumped to a heated tank and stirred while heating at 80° C. From this tank it is pumped to the pots of a horizontal cocoa press and the filling valves are closed. A pressure of 620 bar is applied until 48.7 kg fat has been expelled. The resultant press cakes are broken up and nibbled into small pieces of less than 10 mm in diameter before milling to a fine powder in a pin mill fitted with mechanical classifier, the milling chamber being cooled by circulating cool air at 12° C. The particle size of the powder is such that 99.5% by weight passes a 75 microns sieve.

### EXAMPLE 3

Low (10%) fat chocolate powder (20 kg) as produced in either Example 1 or 2 was added to water (16.2 kg) at 40° C. with high speed stirring to form a homogenous suspension. This suspension was stabilised by precooling to −4° C. using a scraped surface heat exchanger before being deep frozen to below −40° C. using cold air blast freezing.

The deep frozen mass was granulated and sieved at a temperature not exceeding −40° C. using an Atlas granulator and sieve. Sieving was used to regulate the granule size to not less than 0.5 mm and not greater than 5 mm. This granulated mass was transferred to trays and freeze dried at 0.4 mbar pressure with product temperature not exceeding 40° C.

The granulated powder consisted of soft granules. They had good colour and flavour and were readily reconstituted in water or milk, hot or cold.

### EXAMPLE 4

Low (10%) fat chocolate powder (16 kg) as produced in either Example 1 or 2 and sugar (4 kg) were added to water (16.3 kg) at 40° C. with high speed stirring to form a homogenous suspension. This was pre-cooled to −4° C. using a scraped surface heat exchanger, before being pumped into bar shaped plastic moulds and deep frozen to below −40° C. using cold air blast freezing. The bars were then freeze dried at 0.4 mbar pressure with product temperature not exceeding 40° C.

The bars had a crunchy texture, but pieces were not rough in the mouth where they melted easily and smoothly to deliver good chocolate flavour.

### EXAMPLE 5

Low (10%) fat chocolate granules (5 kg) made according to Example 3 was added in stages to regular (30%) fat milk chocolate (5 kg) being stirred at 40° C. in a Hobart mixer. At completion the mass was in the form of cohesive balls of chocolate. To this mass was added 250 g tempered cocoa butter and 50 g polyglycerol polyricinoleate and slow mixing continued until an apparently homogenous viscous mass had just formed.

This mass was put into moulds. The chocolate demoulded easily and consistently with the chocolate having a glossy surface typical of regular chocolate. The surprising feature of the chocolate was its unique mouthfeel and flavour. It did not stick to the palate and dispersed readily to give a high chocolate flavour impact. It had a density 20% less than regular chocolate.

### EXAMPLE 6

Low (10%) fat chocolate granules (5 kg) made according to Example 3 was added in stages to regular (30%) fat milk chocolate (5 kg) being stirred at 40° C. in a Hobart mixer. At completion the mass was in the form of cohesive balls of chocolate. To this mass was added 250 g tempered cocoa butter and 50 g polyglycerol polyricinoleate and slow mixing continued until the cohesive balls began to stick to one another but the mass was not homogenous.

The mass was transferred to moulds. As in Example 3 demoulding was easy, the chocolate had a glossy surface, and the mouthfeel and flavour showed the same features. In this instance however there was a 50% reduction in density of chocolate compared with regular milk chocolate.

### EXAMPLE 7

Low (10%) fat chocolate powder (3 kg) as produced in either Example 1 or 2 was fluidized by air injection in a pilot scale Huttlin granulator/dryer. Water (900 g) was sprayed onto the powder during 9 minutes while the inlet air temperature was 58° C. with humidity 2.5% and the product temperature was 38° C. The agglomerated mass was dried during 11 minutes using inlet air at 85° C. with the product temperature rising from 38° C. to 51° C. The range of particle sizes was 0.3 mm to 0.8 mm with a mean particle size of 0.5 mm, while the bulk density was substantially unchanged by granulation. The granules had good chocolate flavour.

1. A process for producing granulated reduced fat chocolate powder wherein reduced fat chocolate powder is formed by a process comprising the steps of
i) mixing together chocolate making ingredients including at least one cocoa ingredient selected from the group consisting of cocoa liquor, cocoa butter, cocoa butter substitutes and non fat cocoa solids, and at least one sweetener selected from the group of sugar and other sweeteners so as to produce a chocolate composition having a fat content which is higher than that required in the reduced fat chocolate to be manufactured,
ii) subjecting said chocolate composition to a flavour development step by conching, and
iii) after said conching step, removing some of the fat from said chocolate composition to reduce the fat content to a level of less than 18% by weight and wherein the resulting reduced fat chocolate powder has a particle size of less than 100 microns;
the granulation is characterised in that the process comprises the steps of
agglomerating the reduced fat chocolate powder by addition of an aqueous composition to produce agglomerated powder and
drying to remove the aqueous composition forming granules of up to 5 mm in diameter.

2. A process according to claim 1 wherein the process of removing fat from said chocolate composition is carried out using a press, preferably a cocoa press.

3. A process according to claim 1 wherein the process of removing fat from said chocolate composition is carried out by solvent extraction and/or centrifugation.

4. A process according to claim 2 or 3 wherein the process of removing fat from said chocolate composition is carried out using a cocoa press, subsequently a further fat reduction step is carried out which comprises solvent extraction and/or centrifugation.

5. A process according to claim 2 or 3 wherein the reduced fat chocolate powder produced has a fat content of about 7 to 17% by weight and preferably about 9 to 12% by weight.

6. A process according to claim 4 wherein a very low fat chocolate powder containing less than or equal to 1% fat by weight is obtained for use in, the granulation process.

7. A process according to claim 1 wherein the aqueous composition is sprayed onto or into a fluidised mass or moving flow of the reduced fat chocolate powder.

8. A process according to any one of the preceding claims which additionally comprises fluidisation of the agglomerated powder on a vibrating bed before the drying step additionally or alternatively the process comprises cooling of the agglomerate simultaneously with or after the drying step.

9. A process according to claim 7 or 8 wherein sugar is added to the reduced fat chocolate powder and wherein the resulting granules are crunchy.

10. A process according to any one of claims 1 to 6 wherein agglomeration and drying are part of a freeze drying process carried out on the reduced fat chocolate powder.

11. A process for producing granulated reduced fat chocolate powder wherein reduced fat chocolate powder is formed by a process comprising the steps of
i) mixing together chocolate making ingredients including at least one cocoa ingredient selected from the group consisting of cocoa liquor, cocoa butter, cocoa butter substitutes and non fat cocoa solids, and at least one sweetener selected from the group of sugar and other sweeteners so as to produce a chocolate composition having a fat content which is higher than that required in the reduced fat chocolate to be manufactured,
ii) subjecting said chocolate composition to a flavour development step, and
iii) after said flavour development step, removing some of the fat from said chocolate composition to reduce the fat content to a level of less than 18% by weight and wherein the resulting reduced fat chocolate powder has a particle size of less than 100 microns;
the granulation is characterised in that the process comprises the steps of
agglomerating the reduced fat chocolate powder by addition of an aqueous composition to produce agglomerated powder and
drying to remove the aqueous composition forming granules of up to 5 mm in diameter, and wherein agglomeration and drying are part of a freeze drying process carried out on the reduced fat chocolate powder.

12. A process according to claim 10 or 11 wherein the freeze drying process comprises the steps of
a) suspension or dissolution in an aqueous composition of said reduced fat chocolate powder to produce a suspension/solution of the reduced fat chocolate powder;
c) freezing to below −20° C. to create a frozen slab of suspended or dissolved powder;
d) granulation of the frozen slab to give granule sizes of about 0.5 mm to 5 mm in diameter; and
e) removing the aqueous composition from the granule at a pressure less than 1 mbar.

13. A process according to claim 12 which additionally comprises step b) between steps a) and c) comprising stabilizing the suspension/solution by foaming with carbon dioxide or nitrogen and/or precooling the solution/suspension before the freezing step c) to 5° C. to 0° C.

14. A process according to claim 12 or 13 which additionally comprises step f) after step e) comprising recovering aromatic volatiles lost during freeze drying.

15. A process according to any one of claims 12 to 14 wherein sugar is added to the mixture at step a) resulting in granules which are crunchy.

16. A process according to claim 13 wherein the precooling temperature at step b) is about −3 or −4° C.

17. A process according to claim 12 wherein step c) comprises cold air blast or using a freezing drum.

18. A process according to claim 12 wherein the low pressure used at step e) is about 0.4 to 0.6 mbar.

19. A process according to any preceding claim which includes an extra step of manipulating the granules obtained, preferably by sieving, to obtain granules within a specific size range.

20. Use of granulated reduced fat chocolate powder made according to any preceding claim in the manufacture of a chocolate product.

21. A reduced fat chocolate product made with the granulated reduced fat chocolate powder produced by the process of any one of claims 1 to 19.

22. A reduced fat chocolate product according to claim 21 wherein the ingredients comprise
up to 55% of the granulated reduced fat chocolate powder and
chocolate containing 25-45% fat, and
optionally another fat containing ingredient, preferably cocoa butter.

23. A tempered reduced fat chocolate product wherein the ingredients comprise
up to 55% granulated reduced fat chocolate powder produced by the process of any one of claims 1 to 19 and
tempered chocolate containing 25-45% fat.
